(19) United States
(12) Patent Application Publication
(10) Pub. No.: US 2026/0261740 A1
(43) Pub. Date: Sep. 3, 2026

(54) LIVE STREAMING

(71) Applicant: Beijing Zitiao Network Technology Co., Ltd., Beijing (CN)

(72) Inventors: Qingong WANG, Beijing (CN); Zhiming YANG, Beijing (CN); Yanzhe XIN, Beijing (CN)

(21) Appl. No.: 19/460,119

(22) Filed: Jan. 26, 2026

(30) Foreign Application Priority Data
Feb. 28, 2025 (CN) 202510241417.5

(51) Int. Cl. H04N 21/81; G06F 40/58; H04N 21/2187; H04N 21/233

(52) U.S. Cl. CPC H04N 21/8106; G06F 40/58; H04N 21/2187; H04N 21/233

(57) ABSTRACT

According to embodiments of the disclosure, a method, an apparatus, a device and a storage medium for live streaming are provided. The method includes determining, based on audio data of a first live streaming content stream, a first text content corresponding to a first audio segment in the audio data; translating the first text content into a second text content corresponding to a target language; generating, based on the second text content and at least one audio parameter, a second audio segment corresponding to the target language; and replacing the first audio segment in the audio data with the second audio segment to construct a second live streaming content stream corresponding to the target language. In this way, the embodiments of the present disclosure may provide live streaming content streams of different languages, thereby improving the quality of the content of live streaming.

### CROSS-REFERENCE

The present application claims priority to Chinese Patent Application No. 202510241417.5, filed on Feb. 28, 2025, and entitled " METHOD, APPARATUS, DEVICE AND STORAGE MEDIUM FOR LIVE STREAMING", which is hereby incorporated by reference in its entirety.

### TECHNICAL FIELD

Example embodiments of the present disclosure generally relate to the field of computers, and in particular, to live streaming.

### BACKGROUND

With the development of the Internet, viewers of live streaming are no longer limited to a specific region, and a live streaming may be viewed by viewers from regions where different languages are spoken. Generally, a streaming host or a live room uses a specific language for live streaming, which may be referred to as a source language. In this case, because the source language used for the live streaming is different from languages of some regions, some viewers who do not understand the source language of the live streaming cannot understand the content of the live streaming.

### SUMMARY

In a first aspect of the present disclosure, a method for live streaming is provided. The method includes: determining, based on audio data of a first live streaming content stream, a first text content corresponding to a first audio segment in the audio data; translating the first text content into a second text content corresponding to a target language; generating, based on the second text content and at least one audio parameter, a second audio segment corresponding to the target language; and replacing the first audio segment in the audio data with the second audio segment to construct a second live streaming content stream corresponding to the target language.

In a second aspect of the present disclosure, an apparatus for live streaming is provided. The apparatus includes: a first determination module configured to determine, based on audio data of a first live streaming content stream, a first text content corresponding to a first audio segment in the audio data; a translation module configured to translate the first text content into a second text content corresponding to a target language; a generation module configured to generate, based on the second text content and at least one audio parameter, a second audio segment corresponding to the target language; and a replacement module configured to replace the first audio segment in the audio data with the second audio segment to construct a second live streaming content stream corresponding to the target language.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores thereon a computer program executable by a processor to implement the method of the first aspect.

It would be appreciated that the content described in the Summary section of the present disclosure is neither intended to define key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1A to FIG. 1C show schematic diagrams of example environments in which the embodiments according to the present disclosure may be implemented;

FIG. 2 shows an example interface according to some embodiments of the present disclosure;

FIG. 3 shows a flowchart of an example process for live streaming according to some embodiments of the present disclosure;

FIG. 4 shows a schematic structural block diagram of an example apparatus for live streaming according to some embodiments of the present disclosure; and

FIG. 5 shows a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although certain embodiments of the present disclosure are shown in the drawings, it would be appreciated that the present disclosure may be implemented in various forms and should not be construed as limited to the embodiments set forth herein. On the contrary, these embodiments are provided for a more thorough and complete understanding of the present disclosure. It would be appreciated that the drawings and embodiments of the present disclosure are only for illustrative purposes, and are not for limiting the protection scope of the present disclosure.

It should be noted that the titles of any section/subsection provided herein are not restrictive. Various embodiments are described throughout this article, and any type of embodiment may be included under any section/subsection. Furthermore, the embodiments described in any section/subsection may be combined with any other embodiments described in the same section/subsection and/or different section/subsection in any manner.

In the description of the embodiments of the present disclosure, the term "include/comprise" and similar terms thereto should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

The embodiments of the present disclosure may involve user's data, acquisition and/or use of data, etc. These aspects all comply with corresponding laws, regulations and related provisions. In the embodiments of the present disclosure, all data collection, acquisition, processing, machining, forwarding, use, etc. are carried out on the premise that the user is aware of and confirms. Accordingly, when implementing the embodiments of the present disclosure, the user should be informed of the type, range of use, use scenarios, etc. of data or information that may be involved and the authorization of the user should be obtained in an appropriate manner in accordance with relevant laws and regulations. The specific manner of informing and/or authorizing may vary according to actual situations and application scenarios, and the scope of the present disclosure will not be limited in this regard.

If the solutions in this specification and the embodiments involve personal information processing, the processing will be carried out on the premise that there is a legal basis (for example, the consent of the personal information subject is obtained, or it is necessary for the performance of a contract, etc.), and the processing will only be carried out within the scope of regulations or agreements. If a user refuses to process personal information other than the necessary information required for basic functions, it will not affect the user's use of the basic functions.

As mentioned above, with the development of the Internet, viewers of live streaming are no longer limited to a specific region, and a live streaming may face to regions where different languages are spoken. Generally, a streamer or a live streaming room uses a specific language for live streaming, which may be referred to as a source language. In this case, because the source language used for the live streaming is different from languages of some regions, some viewers who do not understand the source language of the live streaming cannot understand the content of the live streaming, thus affecting the efficiency of obtaining the content of the live streaming.

The embodiments of the present disclosure provide a solution for live streaming. According to the solution, a first text content corresponding to a first audio segment in audio data may be determined based on the audio data of a first live streaming content stream. Further, the first text content may be translated into a second text content corresponding to a target language. Further, a second audio segment corresponding to the target language may be generated based on the second text content and at least one audio parameter. Additionally, the first audio segment in the audio data may be replaced with the second audio segment to construct a second live streaming content stream corresponding to the target language.

Based on this approach, in the embodiments of the present disclosure, by determining the first text content of the first audio segment in the audio data, the accuracy of speech recognition of the audio data may be improved. Further, in the embodiments of the present disclosure, by translating the first text content into the second text content corresponding to the target language, the second audio segment corresponding to the target language is generated based on the second text content and the at least one audio parameter, so that a translated speech related to the at least one audio parameter may be obtained. Therefore, the embodiments of the present disclosure may support providing live streaming content streams of different languages by translating speech content of a live streaming stream, so as to facilitate viewers under different languages to understand the content of live streaming, and improve the quality of the content of live streaming presented based on such second live streaming content stream.

Therefore, the embodiments of the present disclosure may provide live streaming content streams of different languages, thereby improving the quality of the content of live streaming.

Various example implementations of the solution will be described in detail below further in conjunction with the drawings.

### Example Environment

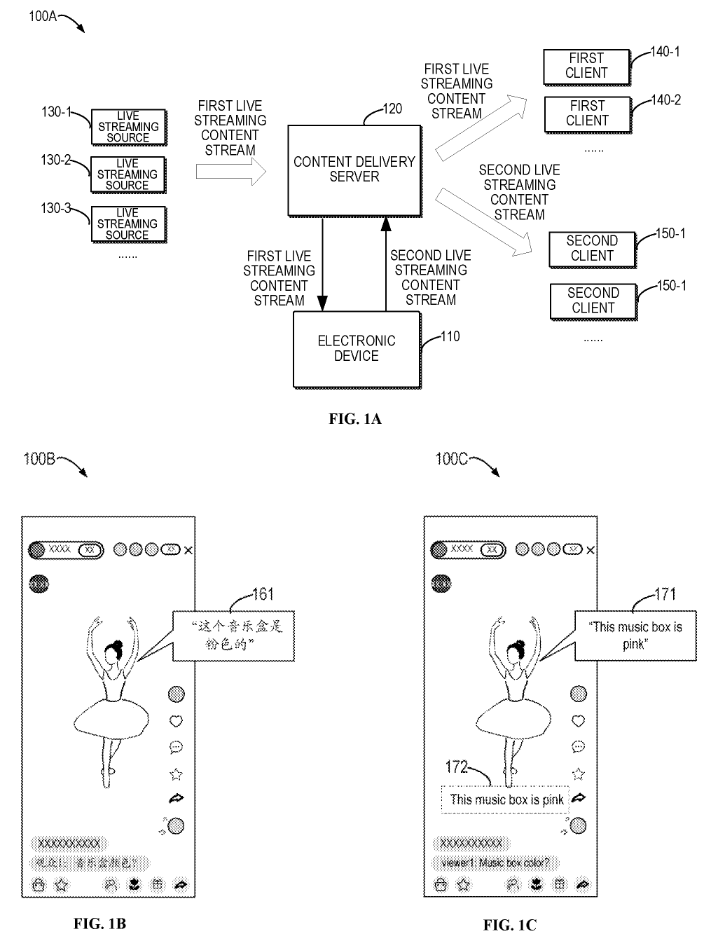

FIG. 1A shows a schematic diagram of an example environment 100A in which the embodiments of the present disclosure can be implemented. As shown in FIG. 1A, the example environment 100A may include an electronic device 110 and a content delivery server 120.

In the example environment 100A, the content delivery server 120 receives (or obtains) some live streaming content streams, for example, a first live streaming content stream, from a live streaming source. As an example, such a live streaming source includes but is not limited to a live streaming platform, a live streaming application, etc. Illustratively, the live streaming source includes, for example, a live streaming source 130-1, a live streaming source 130-2 and a live streaming source 130-3, which may also be collectively or individually referred to as a live streaming source 130.

Further, the electronic device 110 may obtain the first live streaming content stream from such a content delivery server 120, and perform processing such as translation for the first live streaming content stream to construct a second live streaming content stream corresponding to a target language, and provide such a second live streaming content stream to the content delivery server 120.

Therefore, the content delivery server 120 delivers such a first live streaming content stream or such a second live streaming content stream to a corresponding client. For ease of distinction, for example, a first client desires to watch live streaming via the source language, and a second client desires to watch live streaming via the target language, therefore, the content delivery server 120 may deliver the first live streaming content stream to the first client, and deliver the second live streaming content stream to the second client.

As an example, such a first client includes, for example, a first client 140-1 and a first client 140-2, which may also be collectively or individually referred to as a first client 140. Such a second client includes, for example, a second client 150-1 and a second client 150-2, which may also be collectively or individually referred to as a second client 150. It would be appreciated that the numbers of live streaming sources, first clients and second clients shown in FIG. 1A are only illustrative, and are not intended to be any limitation.

For ease of understanding, the live streaming that may be participated in by viewers of different languages is further described below in conjunction with FIG. 1B to FIG. 1C. FIG. 1B to FIG. 1C show schematic diagrams of live streaming interfaces corresponding to live streaming content streams according to the embodiments of the present disclosure.

As an example, as shown in FIG. 1B, the system language in a live streaming interface 100B may be Chinese, and a streamer uses Chinese for live streaming. For example, the live streaming stream may include speech content 161 of the streamer, for example, “这个音乐盒是粉色的”. In this case, viewers whose daily language is English may not be able to understand the content of the live streaming presented by the streamer.

As will be described in detail below, the embodiments of the present disclosure may provide a translated live streaming content stream by translating the speech content 161 in the live streaming content stream. For example, a live streaming interface 100C shown in FIG. 1C may be provided for viewers whose daily language is English. Such a live streaming interface 100C may provide a translated live streaming content stream. As an example, the translated live streaming content stream may include speech content 171 (for example, "This music box is pink") obtained by translating the speech content 161 into a target language (for example, English). In some scenes, picture content of the translated live streaming content stream may further include corresponding subtitle content 172 to help viewers better understand the content of live streaming.

Therefore, viewers in regions of different languages may watch a live streaming via a desired language, and the embodiments of the present disclosure can help the viewers understand the content of live streaming corresponding to the second live streaming content stream more conveniently.

In some embodiments, the electronic device 110 may include a terminal, a server, etc. Such a terminal may be any type of mobile terminal, fixed terminal or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the electronic device 110 may also support any type of interfaces for users (such as "wearable" circuitry, etc.).

Such a server may be an independent physical server, a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. Such a server may include, for example, a computing system/server, such as a mainframe, an edge computing node, a computing device in a cloud environment, and so on.

A communication connection may be established between the electronic device 110 and the content delivery server 120 (or between other multiple terminals, such as between a terminal included in the electronic device 110 and a server, between the live streaming source 130 and the content delivery server 120, between the content delivery server 120 and the client 140 or the client 150, etc.). The communication connection may be established in a wired or wireless manner. The communication connection may include but is not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the electronic device 110 and the content delivery server 120 may implement signaling interaction through the communication connection therebetween.

It would be appreciated that the structures and functions of the elements in the environment 100A are described for illustrative purposes only, without suggesting any limitation to the scope of the present disclosure.

Some example embodiments of the present disclosure will be described below with continued reference to the drawings.

### Example Live streaming Stream Processing

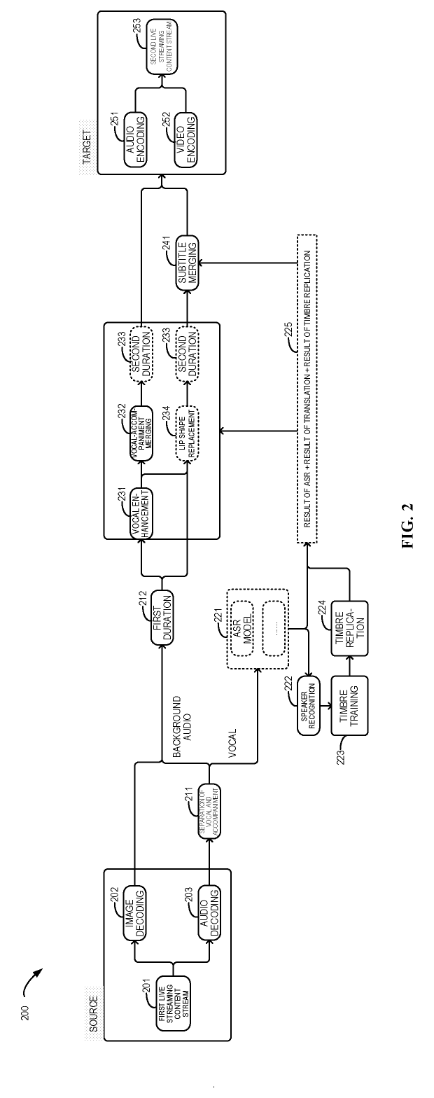

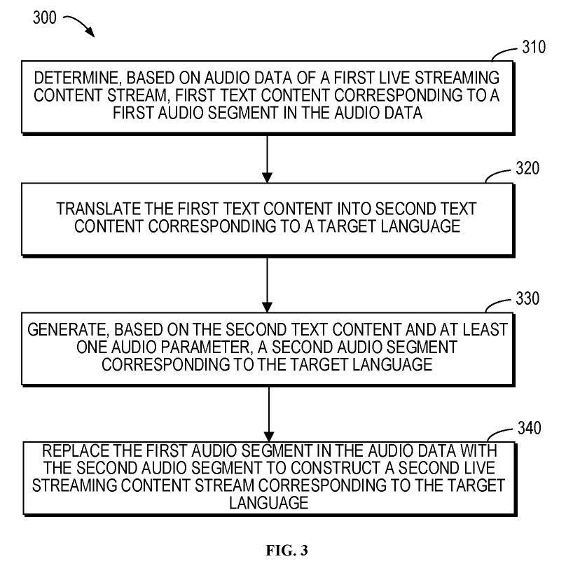

Some processing procedures of live streaming streams according to the embodiments of the present disclosure will be described below with reference to FIG. 2. FIG. 2 shows an example process 200 of live streaming stream processing according to some embodiments of the present disclosure, and the process 200 may be provided, for example, by the electronic device 110 shown in FIG. 1A.

In some embodiments, the electronic device 110 may pull a first live streaming content stream (for example, a first live streaming content stream 201) from the content delivery server 120 and decapsulation such a first live streaming content stream 201. Further, the electronic device 110 may decode the first live streaming content stream 201 to facilitate processing. To ensure decoding accuracy, the electronic device 110 may perform image decoding (202) for the first live streaming content stream 201 to obtain image data, and perform audio decoding (203) for the first live streaming content stream 201 to obtain audio data (also referred to as first audio data). Therefore, the electronic device 110 may translate such audio data. As an example, such image data and audio data may be streaming data to facilitate subsequent real-time live streaming translation. For example, the embodiments of the present disclosure may decode video frames to obtain image data, and decode audio frames to obtain audio data.

In some embodiments, there is a background audio part such as environmental sound and accompaniment music in the audio data. Such a background audio part may bring interference to subsequent audio recognition (for example, speech recognition). Therefore, the electronic device 110 may separate the background audio part and a vocal audio part in the audio data, and then determine a first audio segment from the vocal audio part. As an example, such separation may be implemented by any appropriate audio processing tool that may implement separation of vocal and accompaniment.

In some embodiments, the electronic device 110 may utilize an audio recognition unit 221 to recognize the first audio segment to obtain the first text content corresponding to the first audio segment. As an example, such an audio recognition unit 221 may include at least two optional audio recognition models with different parameter scales to take into account both audio recognition efficiency and model deployment cost. As an example, such an audio recognition model may include any appropriate generative model for recognizing text corresponding to audio, which may perform automatic speech recognition (ASR) based on input audio to generate corresponding text content. Therefore, the electronic device 110 may perform audio recognition for such a first audio segment based on a selected audio recognition model.

Further, the electronic device 110 may translate such a first text content into a second text content corresponding to a target language. As an example, such a target language may be determined by a system or may be set through a received control parameter. As an example, such translation may be implemented by any appropriate text translation model. Therefore, the embodiments of the present disclosure can improve the accuracy of translation by performing text translation for the first text content corresponding to the first audio segment.

In some embodiments, the first audio segment may include speech content corresponding to the target language, and in this case, the speech content corresponding to the target language may be retained to improve the audio quality of the second live streaming content stream 253 that is subsequently constructed. Specifically, the electronic device 110 may determine a source language corresponding to the first text content, and then compare whether the source language and the target language are the same to determine whether to retain the first audio segment.

In some embodiments, if the source language corresponding to the first text content is the same as the target language, the electronic device 110 may retain the first audio segment without translating such a first audio segment. For example, such a first audio segment may be retained in the second live streaming content stream 253 to be subsequently delivered. If the source language corresponding to the first text content is different from the target language, the electronic device 110 may further determine a translation audio corresponding to such a first audio segment. Therefore, the electronic device 110 may reduce the distortion influence brought to the live streaming content stream due to translation.

Specifically, the electronic device 110 may utilize a text-to-speech tool to generate a translation audio segment corresponding to the target language based on the second text content. To improve the audio quality, the electronic device 110 may also control the sound effect of such a translation audio segment via at least one audio parameter. Specifically, the electronic device 110 may utilize a text-to-speech tool to generate the translation audio segment corresponding to the target language based on the second text content and at least one audio parameter. As an example, such at least one audio parameter may be set according to actual project needs. As an example, such a text-to-speech tool may include any tool that may implement generation of speech corresponding to text, such as a text-to-speech (TTS) technology.

In some embodiments, such at least one audio parameter may include at least a timbre parameter, thereby supporting translation into speech content with a designated timbre. As an example, such at least one audio parameter may be configured by a user such as a streamer, for example, a default male voice, a default female voice, etc. configured by the streamer. Therefore, the electronic device 110 may determine such at least one audio parameter based on configuration information associated with the first live streaming content stream 201. As an example, such at least one audio parameter may also be determined by processing the first audio segment, for example, generating the second audio segment with a voiceprint of the original streamer, which may improve the realism of the subsequent second audio segment.

In some scenes, a live streaming may include a plurality of speakers, and therefore a plurality of types of audio parameters may be associated, such as a plurality of types of timbre parameters. Therefore, the electronic device 110 may recognize a speaker identification corresponding to the first audio segment through speaker recognition (222). Further, the electronic device 110 may determine at least one corresponding audio parameter based on the recognized speaker, and train a corresponding timbre feature model through timbre training (223). Based on such a timbre feature model, the electronic device 110 may enable the subsequent second audio segment to have more audio features of the corresponding speaker, thereby improving the audio effect for simulating a real person speaking.

Further, the electronic device 110 may utilize such a timbre feature model and the second text content to obtain the second audio segment corresponding to the target language through timbre replication (224). Therefore, the electronic device 110 may replace the first audio segment in the audio data with such a second audio segment to construct the second live streaming content stream 253 corresponding to the target language. As an example, such a source language, such a second text content, such a second audio segment, etc. may all be stored in a memory unit 225, so as to construct such a second live streaming content stream 253 more conveniently and quickly subsequently.

In some embodiments, in the process of the electronic device 110 replace the first audio segment in the audio data with such a second audio segment, due to some errors of time information, there are abnormal situations such as sudden changes of sound at the connection between the second audio segment and other audio segments in the audio data. Therefore, the embodiments of the present disclosure may generate a third audio segment through translating a part of the first audio segment (for example, a connection part). Further, the electronic device 110 utilize the third audio segment to update such a first audio segment. Such a third audio segment may be associated with a lower volume or a fading volume, so that such a connection part may be made more real and natural, and the effect of the audio data may be improved.

Further, the electronic device 110 may merge such a second audio segment with image data, background audio part, etc. to construct the second live streaming content stream 253. To improve the accuracy of the processes of obtaining the first text content through recognition, obtaining the second text content through translation, etc., the electronic device 110 may set a first duration (for example, a first duration 212) to delay the provision of the image data. Specifically, after decoding to obtain the image data, the electronic device 110 may cache such image data as buffered image data. In the case that the buffered image data reaches the first duration, the electronic device 110 may provide the buffered image data of the first duration as first image data described below. Therefore, such streaming image data may be sent in a segmented manner, thereby improving the accuracy of the processes of obtaining the first text content through recognition, obtaining the second text content through translation, etc. Additionally, the electronic device 110 may improve the matching degree between audio and video in the second live streaming content stream 253 by controlling a difference between a third duration of the first audio segment and a fourth duration of the second audio segment to be less than a threshold value. As an example, such a threshold value may be determined through experiments, prior knowledge, etc.

In some embodiments, there is a case where the volume of such a second audio segment is inconsistent with the volume of other audio segments in the audio data, which may affect the subsequent viewer's feeling of participation in live streaming. Therefore, the electronic device 110 may adjust the volume of such a second audio segment through vocal enhancement (231) to balance the volume of the second audio segment and the volume of other audio segments in the audio data. Further, the electronic device 110 may perform vocal-accompaniment merging (232) for such a second audio segment and the separated background audio part described above to obtain second audio data, so as to improve the audio quality.

In some embodiments, due to the language difference between the second text content and the first text content, the movement of a predetermined object (for example, a face object) in the image data of the first live streaming content stream 201 may not match the second audio segment, resulting in a low realism of the formed subsequent second live streaming content stream 253. Based on this, the electronic device 110 may update the predetermined object in the first image data of the first live streaming content stream 201 at least based on the second audio segment to obtain second image data, and then determine the second live streaming content stream 253 corresponding to the target language by merging the second audio data and the second image data.

Taking the predetermined object being a face object as an example, the electronic device 110 may update, based on the second audio segment, the face object in the first image data of the first live streaming content stream 201 through lip shape replacement (234). Such lip shape replacement may be implemented by any appropriate driving tool. Such a driving tool may be configured to update the face object in the first image data to present a movement matching the second audio segment. For example, the lip movement of the face object may be updated to match the lip shape of the translated speech content. Therefore, the embodiments of the present disclosure may improve the matching degree between the second audio data and the second image data in the second live streaming data.

In some embodiments, the electronic device 110 may merge the second audio data with the second image data. To ensure the alignment between the second audio data and the second image data. The electronic device 110 may merge the second audio data and the second image data after a second duration 233 following an obtaining of the second audio data. Therefore, the embodiments of the present disclosure can further improve the quality of the constructed second live streaming content stream 253.

In some embodiments, the electronic device 110 may further add subtitle data corresponding to the second audio data to the second live streaming content stream 253 through subtitle merging (241). Therefore, the viewer participating in such live streaming may obtain information of speaking more efficiently from the live streaming supported by the second live streaming content stream 253. That is, the information obtaining efficiency of the viewer may be improved. Further, the electronic device 110 may encode such a second audio segment and such a second image data through audio encoding (251) and image encoding (252), respectively, to construct the second live streaming content stream 253. Therefore, the electronic device 110 may provide such a second live streaming content stream 253 to the content delivery server 120. Further, the content delivery server 120 may deliver such a second live streaming content stream 253 to a designated client (for example, the second client 150). As an example, such a designated client may include a client that expects to participate in live streaming in a target language, etc. The present disclosure is not intended to limit the specific manner in which the content delivery server 120 determines such a designated client.

In some embodiments, the acquisition and use of user-related data (such as timbre and voiceprint) involved in the above processes of timbre replication, timbre training, etc., and the applications of timbre replication, timbre training, etc. are all carried out with user's knowledge and permission, and all comply with corresponding laws, regulations and related provisions.

Based on this approach, in the embodiments of the present disclosure, by determining the first text content of the first audio segment in the audio data, the accuracy of speech recognition of the audio data may be improved. Further, in the embodiments of the present disclosure, by translating the first text content into the second text content corresponding to the target language, the second audio segment corresponding to the target language is generated based on the second text content and the at least one audio parameter, so that a translated speech related to the at least one audio parameter may be obtained. Therefore, the embodiments of the present disclosure may support the second live streaming content stream live-streamed with the translated speech content, so that live streaming content streams of different languages may be provided, which facilitates the understanding of the content of live streaming by viewers under different languages, and improves the quality of the content of live streaming presented based on such a second live streaming content stream.

Therefore, the embodiments of the present disclosure may provide live streaming content streams of different languages, thereby improving the quality of the content of live streaming.

### Example Process

FIG. 3 shows a flowchart of an example process 300 for live streaming according to some embodiments of the present disclosure. The process 300 may be implemented at the electronic device 110. The process 300 is described below with reference to FIG. 1A.

As shown in FIG. 3, at block 310, the electronic device 110 determines, based on audio data of a first live streaming content stream, a first text content corresponding to a first audio segment in the audio data.

At block 320, the electronic device 110 translates the first text content into a second text content corresponding to a target language.

At block 330, the electronic device 110 generates, based on the second text content and at least one audio parameter, a second audio segment corresponding to the target language.

At block 340, the electronic device 110 replaces the first audio segment in the audio data with the second audio segment to construct a second live streaming content stream corresponding to the target language.

In some embodiments, the process 300 further includes: determining the at least one audio parameter by processing the first audio segment; or determining the at least one audio parameter based on configuration information associated with the first live streaming content stream.

In this way, the embodiments of the present disclosure can improve the audio quality of the subsequent second live streaming content stream through the at least one audio parameter, thereby improving the quality of live streaming supported by the second live streaming content stream.

In some embodiments, the at least one audio parameter at least includes a timbre parameter.

In this way, the embodiments of the present disclosure may configure audio data satisfying a designated timbre for the second live streaming content stream, thereby improving the quality of the translated audio content.

In some embodiments, the process 300 further includes: separating a background audio part and a vocal audio part in the audio data; and determining the first audio segment from the vocal audio part.

In this way, the embodiments of the present disclosure may reduce the interference of the background audio part for the subsequent language recognition, thereby improving the accuracy of the subsequent first text content.

In some embodiments, replacing the first audio segment in the audio data with the second audio segment includes: determining a source language corresponding to the first text content; and replacing, in response to the source language being different from the target language, the first audio segment in the audio data with the second audio segment.

In this way, the embodiments of the present disclosure may replace the first audio segment only in a case where the first audio segment corresponds to a source language different from the target language, which may improve the audio quality of the subsequent second live streaming content stream.

In some embodiments, the process 300 further includes: retaining, in response to the source language being the same as the target language, the first audio segment in the second live streaming content stream.

In this way, the embodiments of the present disclosure may retain the first audio segment in a case where the first audio segment corresponds to the target language, and thus may improve the audio quality of the subsequent second live streaming content stream through such original audio (the first audio segment).

In some embodiments, the process 300 further includes: updating the first audio segment in the second live streaming content stream based on a third audio segment associated with the first audio segment in the second live streaming content stream, where the third audio segment is generated through translation.

In this way, the embodiments of the present disclosure may reduce noise caused by the replacement of the audio segment, thereby further improving the audio quality of the subsequent second live streaming content stream.

In some embodiments, the audio data is first audio data, and replacing the first audio segment in the first audio data with the second audio segment to construct the second live streaming content stream corresponding to the target language includes: replacing the first audio segment in the first audio data with the second audio segment to obtain second audio data corresponding to the target language; updating, based at least on the second audio segment, a predetermined object in first image data of the first live streaming content stream to obtain second image data; and determining, by merging the second audio data and the second image data, the second live streaming content stream corresponding to the target language.

In this way, the embodiments of the present disclosure may provide the second image data better matching the second audio segment in the second live streaming content stream thereby achieving a higher matching degree between audio and video, and the realism of the second live streaming content stream may be increased.

In some embodiments, the process 300 further includes: obtaining buffered image data of the first live streaming content stream; and providing, in response to the buffered image data reaching a first duration, the buffered image data of the first duration as the first image data.

In this way, the embodiments of the present disclosure may improve the alignment degree between audio and video in the subsequent second live streaming content stream, thereby further improving the quality of the subsequent second live streaming content stream.

In some embodiments, determining, by merging the second audio data and the second image data, the second live streaming content stream corresponding to the target language includes: determining, after a second duration following an obtaining of the second audio data, the second live streaming content stream corresponding to the target language by merging the second audio data and the second image data.

In this way, the embodiments of the present disclosure may ensure the temporal alignment between the merged second audio data and the second image data, thereby further improving the quality of the subsequent second live streaming content stream.

In some embodiments, a difference between a third duration of the first audio segment and a fourth duration of the second audio segment is less than a threshold value.

In this way, the embodiments of the present disclosure may improve the temporal matching degree between audio and image before and after the replacement, and reduce the occurrence probability of unreasonable audio-video asynchronization.

In some embodiments, the process 300 further includes: determining subtitle data corresponding to the second text content; and adding the subtitle data to the second live streaming content stream.

In this way, the embodiments of the present disclosure may improve the efficiency of the viewer obtaining information from the second live streaming content stream.

In some embodiments, the process 300 includes: before replacing the first audio segment in the audio data with the second audio segment, adjusting a volume of the second audio segment.

In this way, the embodiments of the present disclosure may balance the volume of the audio data in the second live streaming content stream, thereby improving the audio quality of the second live streaming content stream.

In some embodiments, the process 300 further includes: obtaining the first live streaming content stream from a content delivery server, and the process 300 further includes: after constructing the second live streaming content stream, providing the constructed second live streaming content stream to the content delivery server for delivering the second live streaming content stream to a designated client.

In this way, the embodiments of the present disclosure can support the content delivery server to deliver live streams live-streamed via different languages to clients with different language requirements, thereby improving the live streaming experience and the efficiency of information obtaining of the corresponding viewer.

### Example Apparatus and Device

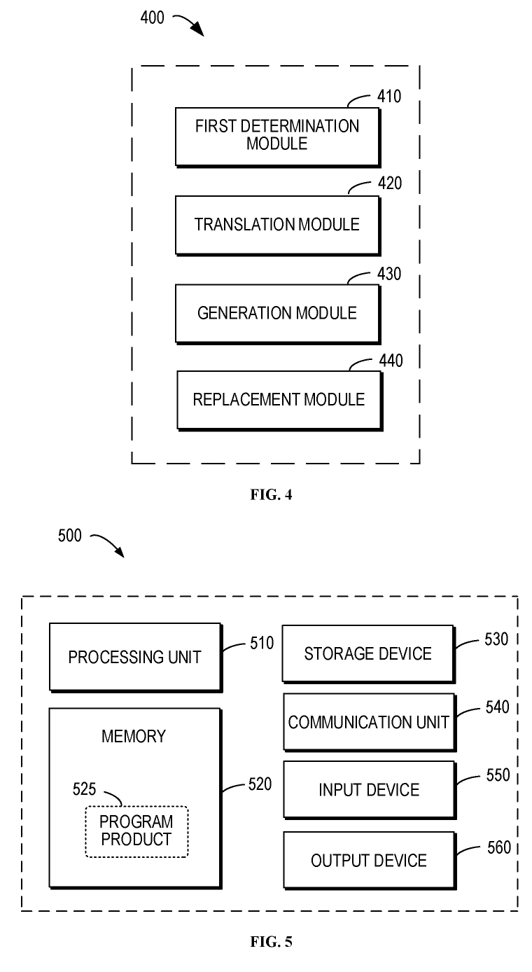

The embodiments of the present disclosure further provide a corresponding apparatus for implementing the above method or process. FIG. 4 shows a schematic structural block diagram of an example apparatus 400 for live streaming according to some embodiments of the present disclosure. The apparatus 400 may be implemented as the electronic device 110 or included in the electronic device 110. Each module/component in the apparatus 400 may be implemented by hardware, software, firmware, or any combination thereof.

As shown in FIG. 4, the apparatus 400 includes a first determination module 410 configured to determine, based on audio data of a first live streaming content stream, a first text content corresponding to a first audio segment in the audio data; a translation module 420 configured to translate the first text content into a second text content corresponding to a target language; a generation module 430 configured to generate, based on the second text content and at least one audio parameter, a second audio segment corresponding to the target language; and a replacement module 440 configured to replace the first audio segment in the audio data with the second audio segment to construct a second live streaming content stream corresponding to the target language.

In some embodiments, the apparatus 400 further includes a second determination module configured to: determine the at least one audio parameter by processing the first audio segment; or determine the at least one audio parameter based on configuration information associated with the first live streaming content stream.

In some embodiments, the at least one audio parameter at least includes a timbre parameter.

In some embodiments, the apparatus 400 further includes a third determination module configured to: separate a background audio part and a vocal audio part in the audio data; and determine the first audio segment from the vocal audio part.

In some embodiments, the replacement module 440 is further configured to: determine a source language corresponding to the first text content; and replace, in response to the source language being different from the target language, the first audio segment in the audio data with the second audio segment.

In some embodiments, the apparatus 400 further includes a retaining module configured to: retaining, in response to the source language being the same as the target language, the first audio segment in the second live streaming content stream.

In some embodiments, the apparatus 400 further includes an updating module configured to: update the first audio segment in the second live streaming content stream based on a third audio segment associated with the first audio segment in the second live streaming content stream, where the third audio segment is generated through translation.

In some embodiments, the audio data is first audio data, and the replacement module 440 is further configured to: replace the first audio segment in the first audio data with the second audio segment to obtain second audio data corresponding to the target language; update, based at least on the second audio segment, a predetermined object in first image data of the first live streaming content stream to obtain second image data; and determine, by merging the second audio data and the second image data, the second live streaming content stream corresponding to the target language.

In some embodiments, the apparatus 400 further includes a first provision module configured to: obtain buffered image data of the first live streaming content stream; and providing, in response to the buffered image data reaching a first duration, the buffered image data of the first duration as the first image data.

In some embodiments, the replacement module 440 is further configured to: determine, after a second duration following an obtaining of the second audio data, the second live streaming content stream corresponding to the target language by merging the second audio data and the second image data.

In some embodiments, a difference between a third duration of the first audio segment and a fourth duration of the second audio segment is less than a threshold value.

In some embodiments, the apparatus 400 further includes an adding module configured to: determine subtitle data corresponding to the second text content; and add the subtitle data to the second live streaming content stream.

In some embodiments, the apparatus 400 further includes an adjusting module configured to: adjust a volume of the second audio segment.

In some embodiments, the apparatus 400 further includes an obtaining module configured to obtain the first live streaming content stream from a content delivery server, and the apparatus 400 further includes a second provision module configured to provide the constructed second live streaming content stream to the content delivery server for delivering the second live streaming content stream to a designated client.

The modules included in the apparatus 400 may be implemented in various ways, including software, hardware, firmware, or any combination thereof. In some embodiments, one or more units may be implemented using software and/or firmware, for example machine executable instructions stored on a storage medium. In addition to machine executable instructions, or as an alternative, a part of or all of modules in the apparatus 400 may be implemented at least partially by one or more hardware logic components. As an example, rather than a limitation, example types of hardware logic components that may be used include field programmable gate array (FPGA), application specific integrated circuit (ASHC), application specific standard (ASSP), system on chip (SOC), complex programmable logic device (CPLD), and so on.

FIG. 5 shows a block diagram of an electronic device 500 in which one or more embodiments of the present disclosure may be implemented. It would be appreciated that the electronic device 500 shown in FIG. 5 is merely illustrative and should not constitute any limitation to the functions and scope of the embodiments described herein. The electronic device 500 shown in FIG. 5 may be configured to implement the electronic device 110 in FIG. 1A or the apparatus 400 in FIG. 4.

As shown in FIG. 5, the electronic device 500 is in the form of a general electronic device. The components of the electronic device 500 may include but are not limited to one or more processors or processing units 510, a memory 520, a storage device 530, one or more communication units 540, one or more input devices 550, and one or more output devices 560. The processing unit 510 may be an actual or virtual processor and may execute various processes based on the programs stored in the memory 520. In a multiprocessor system, multiple processing units execute computer executable instructions in parallel to improve the parallel processing capability of the electronic device 500.

The electronic device 500 typically includes a plurality of computer storage medium. Such medium may be any available medium that is accessible to the electronic device 500, including but not limited to volatile and non-volatile medium, removable and non-removable medium. The memory 520 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 520 may include a computer program product 525, which has one or more program modules configured to perform various methods or acts of the various embodiments of the present disclosure.

The communication unit 540 implements communication with other electronic devices through the communication medium. Additionally, the functions of the components of the electronic device 500 may be implemented by a single computing cluster or a plurality of computing machines, which may communicate through communication connections. Therefore, the electronic device 500 may use a logical connection with one or more other servers, a network personal computer (PC) or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown, such as a storage device, a display device, etc.) through the communication unit 540 as needed, communicate with one or more devices that enable the user to interact with the electronic device 500, or communicate with any device (such as a network card, a modem, etc.) that enables the electronic device 500 to communicate with one or more other electronic devices. Such communication may be performed via input/output (H/O) interfaces (not shown).

According to an illustrative implementation of the present disclosure, there is provided a computer-readable storage medium having computer executable instructions stored thereon, where the computer executable instructions are executed by a processor to implement the method described above. According to an illustrative implementation of the present disclosure, there is further provided a computer program product tangibly stored on a non-transitory computer-readable medium and including computer executable instructions, and the computer executable instructions are executed by a processor to implement the method described above.

Various aspects of the present disclosure are described herein with reference to flowcharts and/or block diagrams of methods, apparatuses, devices and computer program products implemented according to the present disclosure. It would be appreciated that each block of the flowcharts and/or block diagrams, and combinations of blocks in the flowcharts and/or block diagrams, may be implemented by computer readable program instructions.

These computer readable program instructions may be provided to a processing unit of a general-purpose computer, a special-purpose computer, or other programmable data processing apparatus to produce a machine, such that when these instructions are executed by the processing unit of the computer or other programmable data processing apparatus, an apparatus for implementing the functions/acts specified in one or more blocks of the flowcharts and/or block diagrams is produced. These computer readable program instructions may also be stored in a computer-readable storage medium, and these instructions cause the computer, the programmable data processing apparatus and/or other devices to work in a specific way, so that the computer-readable medium storing the instructions includes a manufactured product, which includes instructions for implementing various aspects of the functions/acts specified in one or more blocks of the flowcharts and/or block diagrams.

The computer readable program instructions may be loaded onto a computer, another programmable data processing apparatus, or other devices, so that a series of operations and steps are performed on the computer, the other programmable data processing apparatus, or the other devices to produce a computer-implemented process, so that the instructions executed on the computer, the other programmable data processing apparatus, or the other devices implement the functions/acts specified in one or more blocks of the flowcharts and/or block diagrams.

The flowcharts and block diagrams in the drawings show the possibly implemented architectures, functions and operations of the systems, methods and computer program products according to multiple implementations of the present disclosure. In this regard, each block in the flowchart or block diagram may represent a module, program segment, or part of an instruction, which contains one or more executable instructions for implementing the specified logical functions. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It should also be noted that each block in the block diagrams and/or flowcharts, and combinations of the blocks in the block diagrams and/or flowcharts may be implemented by a special-purpose hardware-based system that executes specified functions or acts, or may be implemented by a combination of special-purpose hardware and computer instructions.

The implementations of the present disclosure have been described above, and the above description is illustrative, non-exhaustive, and not limited to the disclosed implementations. Without departing from the scope of the illustrated implementations, many modifications and changes will be apparent to those of ordinary skill in the art. The choice of terms used herein is intended to best explain the principles, practical applications, or improvements to the technologies in the market of the implementations, or to enable other ordinary skilled persons in the art to understand the implementations disclosed herein.

1. A method for live streaming, comprising:
determining, based on audio data of a first live streaming content stream, a first text content corresponding to a first audio segment in the audio data;
translating the first text content into a second text content corresponding to a first language;
generating, based on the second text content and at least one audio parameter, a second audio segment corresponding to the first language; and
replacing the first audio segment in the audio data with the second audio segment to construct a second live streaming content stream corresponding to the first language.

2. The method of claim 1, further comprising:
determining the at least one audio parameter by processing the first audio segment; or
determining the at least one audio parameter based on configuration information associated with the first live streaming content stream.

3. The method of claim 2, wherein the at least one audio parameter at least comprises a timbre parameter.

4. The method of claim 1, further comprising:
separating a background audio part and a vocal audio part in the audio data; and
determining the first audio segment from the vocal audio part.

5. The method of claim 1, wherein replacing the first audio segment in the audio data with the second audio segment comprises:
determining a source language corresponding to the first text content; and
replacing, in response to the source language being different from the first language, the first audio segment in the audio data with the second audio segment.

6. The method of claim 5, further comprising:
retaining, in response to the source language being the same as the first language, the first audio segment in the second live streaming content stream.

7. The method of claim 6, further comprising:
updating the first audio segment in the second live streaming content stream based on a third audio segment associated with the first audio segment in the second live streaming content stream, wherein the third audio segment is generated through translation.

8. The method of claim 1, wherein the audio data is first audio data, and replacing the first audio segment in the first audio data with the second audio segment to construct the second live streaming content stream corresponding to the first language comprises:
replacing the first audio segment in the first audio data with the second audio segment to obtain second audio data corresponding to the first language;
updating, based at least on the second audio segment, a predetermined object in first image data of the first live streaming content stream to obtain second image data; and
determining, by merging the second audio data and the second image data, the second live streaming content stream corresponding to the first language.

9. The method of claim 8, further comprising:
obtaining buffered image data of the first live streaming content stream; and
providing, in response to the buffered image data reaching a first duration, the buffered image data of the first duration as the first image data.

10. The method of claim 8, wherein determining, by merging the second audio data and the second image data, the second live streaming content stream corresponding to the first language comprises:
determining, after a second duration following an obtaining of the second audio data, the second live streaming content stream corresponding to the first language by merging the second audio data and the second image data.

11. The method of claim 1, wherein a difference between a third duration of the first audio segment and a fourth duration of the second audio segment is less than a threshold value.

12. The method of claim 1, further comprising:
determining subtitle data corresponding to the second text content; and
adding the subtitle data to the second live streaming content stream.

13. The method of claim 1, wherein, before replacing the first audio segment in the audio data with the second audio segment, the method comprises:
adjusting a volume of the second audio segment.

14. The method of claim 1, further comprising: obtaining the first live streaming content stream from a content delivery server, and
the method further comprising: after constructing the second live streaming content stream, providing the constructed second live streaming content stream to the content delivery server for delivering the second live streaming content stream to a designated client.

15. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
determining, based on audio data of a first live streaming content stream, a first text content corresponding to a first audio segment in the audio data;
translating the first text content into a second text content corresponding to a first language;
generating, based on the second text content and at least one audio parameter, a second audio segment corresponding to the first language; and
replacing the first audio segment in the audio data with the second audio segment to construct a second live streaming content stream corresponding to the first language.

16. The electronic device of claim 15, wherein the acts further comprise:
determining the at least one audio parameter by processing the first audio segment; or
determining the at least one audio parameter based on configuration information associated with the first live streaming content stream.

17. The electronic device of claim 16, wherein the at least one audio parameter at least comprises a timbre parameter.

18. The electronic device of claim 15, wherein the acts further comprise:
separating a background audio part and a vocal audio part in the audio data; and
determining the first audio segment from the vocal audio part.

19. The electronic device of claim 15, wherein replacing the first audio segment in the audio data with the second audio segment comprises:
determining a source language corresponding to the first text content; and
replacing, in response to the source language being different from the first language, the first audio segment in the audio data with the second audio segment.

20. A non-transitory computer-readable storage medium having a computer program stored thereon, the computer program, when executed by a processor, implementing acts comprising:
determining, based on audio data of a first live streaming content stream, a first text content corresponding to a first audio segment in the audio data;
translating the first text content into a second text content corresponding to a first language;
generating, based on the second text content and at least one audio parameter, a second audio segment corresponding to the first language; and
replacing the first audio segment in the audio data with the second audio segment to construct a second live streaming content stream corresponding to the first language.
